(19) United States
(12) Patent Application Publication
(10) Pub. No.: US 2003/0155836 A1
(43) Pub. Date: Aug. 21, 2003

(54) SMALL-SIZE MOTOR

(76) Inventors: SHIGENORI UDA, OSAKA-SHI (JP); HIROSHI TAKAO, YONAGO-SHI (JP); SHIGERU KONDO, HIGASHIOSAKA-SH (JP)

Correspondence Address: WENDEROTH, LIND & PONACK, L.L.P., 2033 K STREET N. W., SUITE 800, WASHINGTON, DC, 20006-1021, US

(21) Appl. No.: 08/545,377

(22) Filed: Oct. 19, 1995

Related U.S. Application Data
(63) Continuation of application No. 07/928,653, filed on Aug. 17, 1992, now abandoned.
Application No. 07/928,653 is a continuation of application No. 07/113,114, filed on Oct. 27, 1987, now abandoned.
Application No. 07/113,114 is a continuation-in-part of application No. 06/760,977, filed on Jul. 31, 1985, now abandoned.

(51) Int. Cl. H02K 13/00

(52) U.S. Cl. 310/239; 310/40 MM

(57) ABSTRACT

A small-size motor of a type comprising brushes and a commutator slidably engaged with the brushes, characterized in that a motor case is filled with an atmosphere containing vapor of at least one organic compound selected from the group consisting of paraffins, mono- or poly-hydric alcohols, ethers, cyclic ethers, esters, ketones, ether alcohols, ester alcohols, aminoalcohols, carboxylic acids, amides, primary, secondary and tertiary amines, imidazoles, imidazolines and monocyclic oxyterpenes, which is stably operated and has a prolonged duration of life.

### FIELD OF THE INVENTION

The present invention relates to a small-size motor. More particularly, it relates to a small-size motor which is filled with an atmosphere containing an organic compound vapor so as to prolong its duration of life.

### BACKGROUND OF THE INVENTION

A small-size motor of a type comprising brushes and commutator elements slidably engaged with the brushes is, for example, used for driving a recording tape of a tape recorder, video tape recorder and the like.

In case of a small-size motor in which make and break of contact most frequently occur, two kinds of brushes are typically used. One of them comprises a sheet or a wire rod of an electrically conductive resilient material (e.g., copper, beryllium-copper alloy, copper-titanium alloy, phosphor bronze and nickel silver) which is cladded with or partially spot welded by a noble metal or its alloy (e.g., gold, palladium, platinum, silver and copper or their alloys). The other comprises the above sheet or wire rod a part of which is provided with a brush element made of sintered carbon (e.g., carbon, Ag-carbon, Cu-carbon, AgCu-carbon, which optionally contain an additive such as SiC, MoS₂, Pb and an epoxy resin) by means of an electrically conductive adhesive, spot welding or calking.

The conventional small-size motor has several drawbacks such that when the commutator rotates with sliding on the brushes, sliding parts of the brushes unavoidably vibrate to an unacceptable extent, which results in abnormal welding of contact surfaces of the sliding parts of the brushes contacting with the commutator segments, and that spark often generates a black material, which is a mixture of carbon and worn powder formed between the brushes and the commutator segment and induces and worsens abnormal phenomena.

In one type of the small-size motor, the sliding part of the brush, which is slidably engaged with the commutator segment, is integrally molded with a brush base supported by a supporting member provided on, for example, a cover of a motor case. A contacting state between the brushes and the commutator segments of such the motor is shown in FIG. 1.

In FIG. 1, bent sliding parts 3,3 of brushes are mounted on respective brush bases 2,2 supported by respective brush supporting means 1,1. The brush bases and the sliding parts of the brushes are inherently resilient so that they are pressed against and in contact with commutator segments 4. The pressure to be exerted by the brushes are adjusted by selecting the angle between the brush base 2 and the sliding part of the brush 3. The commutator segment 4 is fixed on a revolving shaft 6 of the motor via a commutator base 5 and rotates in accordance with the rotation of the motor shaft.

During commutation and on make and break of the contact, spark is generated between the commutator segment 4 and the sliding part of the brush 3 and undesirably causes electric noise, and abrasion or welding of the commutator segment 4 and/or the sliding part of the brush 3.

For instance, when the welding occurs at a part A of the brush where the contact with the commutator begins and ends, the welded material scratches and damages the surface of the commutator segment 4, and the thus abrased chips are trapped in gap B between the adjacent commutator segments to form of circuits between them. This results in unstable rotation of the motor. The rough surface of the commutator segment induces vibration of the brushes, enhances the spark generation and/or causes abnormal abrasion of the brushes, and further induces noise and/or dislocation of the commutation point. These result in the deterioration of the performance of the motor.

The spark is most frequently generated at the part A of the sliding part of the brush 3 with which the commutator segment 4 contacts. Needless to say, the mechanical abrasion due to other causes than the spark is generated on the commutator segment 4 and the sliding part of the brush 3.

The sliding part of the brush is commonly made of the noble metal alloys or the sintered carbon as described in the above, while the commutator segment is made of the noble metal alloy (e.g., AgCu, AgCd, AgCuCd, AgCuTi, etc.). In case of the noble metal brush, the sliding part of the brush and the commutator segment are made of substantially the same material having high surface energy as follows (calculated from the sublimation heats at 20° C. cf. Chem. Rev., 52, 417 (1953)):

Ag (100)=1,920 dyne/cm

Ag (111)=1,650 dyne/cm

Au (100)=2,516 dyne/cm

Au (111)=2,175 dyne/cm

Cu (100)=2,892 dyne/cm

Cu (111)=2,499 dyne/cm

Pt (100)=3,747 dyne/cm

Pt (111)=3,248 dyne/cm.

Thus, the sliding surfaces are disadvantageously scratched. In case of the sintered carbon brush, although it has smaller dynamic resistance than the noble metal alloy, it may scratch the surface of the commutator segment since it contains a small amount of impurities such as SiO₂.

Further, the noble metal-carbon brush is not desirable to be used in combination with the noble metal commutator segment because of the same reason as in case of the noble metal brush.

FIG. 2A shows a brush not having a mechanical means for preventing spark, namely means for damping vibration. Since the sliding part of such brush vibrates with a large amplitude, it frequently induces spark and consequently abrasion and welding of the commutator segment.

FIG. 2B shows a brush having means for damping vibration comprising a rubber vibration insulator 9 adhered on the sliding part of the brush 3 with an adhesive 8. Although the rubber vibration insulator absorbs vibration and prevents generation of the spark at a room temperature, adhesivity of the adhesive is deteriorated at a temperature around 60° C. so that bonding between the insulator 9 and the sliding part 3 is weakened. As the result, the vibration insulating property is degraded and therefore spark is vigorously generated. This means that a motor comprising such brush does not have a long duration of life.

FIG. 2C also shows a brush having another means for damping vibration comprising a vibration insulating sheet 12 adhered on the sliding part of the brush 3 with an adhesive sheet 11 comprising a substrate 10 both surfaces of which are coated with an adhesive 8. The sheet 12 prevents deterioration of the adhesivity of the adhesive at a high temperature to some extent. However, it does not satisfy requirements for a long duration of life and high quality at a high temperature. The small-size motor is often used in a temperature range between −10° C. and +60° C.

Some literatures and experiments have been analyzed conditions under which the welding between the sliding part of the brush and the commutator segment or abnormal abrasion or circuit is caused. In such conditions, an atmosphere surrounding the sliding part of the brush contains, or the commutator segment itself adsorbs an unsaturated cyclic hydrocarbon (e.g., styrene, toluene, etc.), which will form the black material (probably a decomposed material or a carbon-like polymer produced by a mechanochemical reaction or their mixture with powder abrased from the brush and the commutator segment).

The amount of the black material increases when the unsaturated cyclic hydrocarbon is burnt by spark between the sliding part of the brush and the commutator segment. Probably because of incomplete combustion and/or its chemical structure, the material has dense bonding structure to form a hard carbonaceous mass.

It has been found that, although a hydrocarbon other than the unsaturated cyclic hydrocarbon forms a black material, the material is not hard but soft and does not induce the above described abnormal conditions of the motor. According to Examples described below, following results were obtained:

1. At a higher temperature and lower humidity, the commutator segment is more often abnormally abrased.

2. When the commutator segment adsorbs as little as 10 μg of the unsaturated cyclic hydrocarbon, the malfunction of the commutator segment is decreased and the duration of life of the motor is prolonged, but the wow and flutter are worse.

### SUMMARY OF THE INVENTION

One object of the present invention is to provide a small-size motor in which slidability between the brushes and the commutator segment is improved so that wear and welding of them are decreased and thus the abrasion or mechanical loss of them is prevented, which results in a long duration of life of the motor.

Another object of the invention is to provide a small-size motor which improves characteristics such as wow and flutter and a duration of life of a tape recorder and the like in that the motor is installed.

These and other objects are achieved by a small-size motor according to the present invention of a type comprising brushes and a commutator slidably engaged with the brushes, characterized in that the interior is filled with an atmosphere containing vapor of at least one organic compound selected from the group consisting of paraffins, mono- or poly-hydric alcohols, ethers, cyclic ethers, esters, ketones, ether alcohols, ester alcohols, aminoalcohols, carboxylic acids, amides, primary, secondary and tertiary amines, imidazoles, imidazolines and monocyclic oxyterpenes.

### BRIEF EXPLANATION OF THE DRAWINGS

FIG. 1 shows a contact state of brushes and commutator segments of a small-size motor,

FIGS. 2A, 2B and 2C show three embodiments of brushes used in the small-size motor,

FIGS. 3 and 4 show structures of preferred embodiments of the small-size motor of the invention,

FIG. 5 is a cross section of one embodiment of the small-size motor of the invention,

FIGS. 6-1 to 6-22 are graphs of commutating waves of small-size motors used in Examples.

### DETAILED DESCRIPTION OF THE INVENTION

The organic compound is impregnated in a suitable material such as felt, a synthetic or natural plastic or rubber open cell foam and installed in the motor case interior. Alternatively or additionally, it can be directly applied to an element of the motor such as the brush or the sliding part of the brush for simplicity of the motor construction.

The organic compound is vaporized at an ambient temperature so as to provide an atmosphere of its vapor in the motor case interior The evaporated compound is adsorbed by the surfaces of the brush and/or the commutator segment to form a mono- or poly-molecular layer, so that the lubricity of the surface is improved and the abrasion of the surfaces is significantly reduced.

FIGS. 3, 4 and 5 show embodiments of the small-size motor of the present invention.

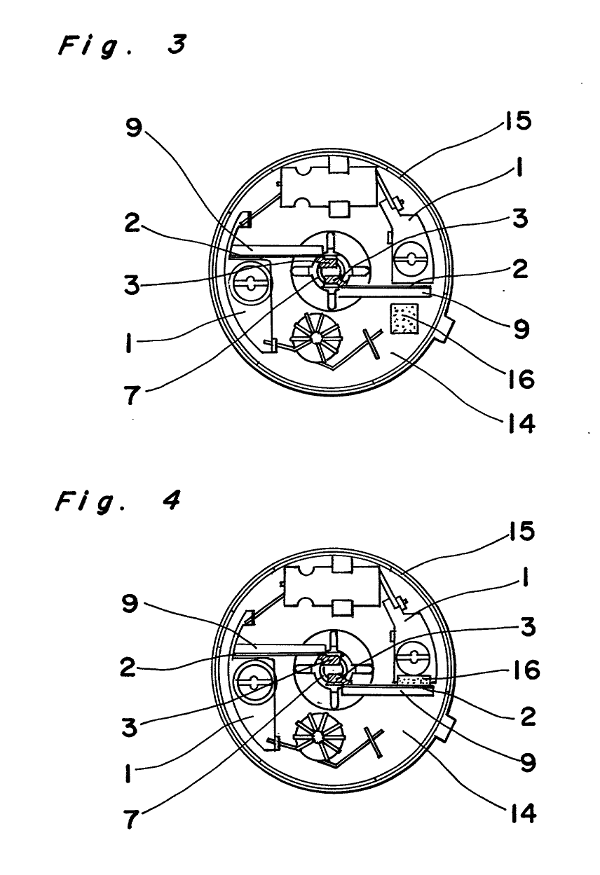

In FIG. 5, the small-size motor comprises an upper motor case 22 and a lower motor case 15. The upper motor case 22 comprises a cylinder shape case having a top covering at one end and an opening at the other end in which a bearing 18 for supporting a shaft 6 is provided at the center of the top covering in a thrust direction. On an inner wall surface of the upper motor case 22, a ring-form permanent magnet 21 is fixed.

The plane lower motor case 15 is installed at the opening of the upper motor case 22 to sealingly close said opening and to form a motor case defining a motor case interior. On the inner surface of the lower motor case 15, installed is a plate-shape plastic bracket 14 for supporting a lower bearing 7 which supports an unloaded end of the shaft 6. The plastic bracket 14 also supports the brushes 13.

To the shaft 6 positioned in the motor case, a rotor core 20 is attached, which faces an inner surface of the magnet 21 with a small air gap therebetween. Around the rotor core 20, coils 19 consisting of magnet wires are wound. In addition, commutator segments 4 and plastic commutator bases 5 are attached to the shaft 6, and with the commutator segments 4, the brushes 3 slidingly contacts. Between the end surface of the magnet 21 in the axis direction and the inner surface of the top covering, there is provided a felt 17 impregnated with the organic compound, and the vapor of the organic compound evaporates from the felt and fills the motor case interior. The evaporation rate of the organic compound can be controlled by selecting a thickness and/or apparent density of the felt.

FIGS. 3 and 4 illustrate other embodiments of the small-size motor of the present invention. In the embodiment of FIG. 3, a felt 16 impregnated with the organic compound is placed on the bracket 14 close to the sliding part of the brush 3, and in the embodiment of FIG. 4, the felt 16 impregnated with the organic compound is placed on the brush 3 together with the rubber vibration insulator 9.

The place where the organic compound-impregnated material is placed or the element in which the organic compound is impregnated is not limited in so far as the place or the element does not interfere or deteriorate the operation of the motor. For example, the organic compound may be blended in the plastic bracket 14 or the plastic commutator base 5, impregnated in the magnetic wire of the coils 19, blended in a lubrication oil of the upper bearing 18 and/or the lower bearing 17, placed in the gap between the magnet 21 and the upper motor case 22, blended in the rubber vibration insulator 9 or the adhesive 8. The organic compound may be contained in a gas permeable film or case made of, for example, polyethylene and placed in the small-size motor.

The organic compound used according to the present invention does not form such hard black material as formed from the unsaturated cyclic hydrocarbon and reduces the sliding resistance between the sliding part of the brush and the commutator segment.

At a high temperature and low humidity at which the abnormal conditions often occur in the motor, the motor case is provided with an atmosphere containing the organic compound. Since the organic material used according to the present invention has at least one polar group and is strongly adsorbed on a metal surface by van der Waals binding, its absorption on the metal surface is stable.

The organic compound has preferably a boiling or sublimation point of 40 to 350° C., particularly 100 to 300° C. under atmospheric pressure. When the boiling or sublimation point is too low, the compound is too quickly evaporated and its effect does not last long. When the boiling point is too high, it is hardly evaporated and the motor case is not quickly filled with the atmosphere containing the compound vapor.

Specific examples of the organic compound used according to the present invention are listed below together with a boiling point under 1 atm. unless otherwise indicated:

Paraffins

2,2,4-trimethylpentane (99.2° C.), n-decane (174.1° C.), n-dodecane (216.3° C.), tetradecane (253.6° C.).

Monohydric alcohols

n-propanol (97.2° C.), isopropanol (81.5-83.0° C.), isobutanol (106-109° C.), isoamyl alcohol (128-132° C.), cyclohexanol (160-162.4° C.), 2,4-dimethyl-3-pentanol (138.4° C.), 3-methyl-3-pentanol (122.4° C.), 3-ethyl-3-pentanol (143.1° C.), diacetone alcohol (167.4° C.), n-octanol (193-196.0° C.), 2-ethylhexanol (183.5° C.), tetrahydrofurfuryl alcohol (177-178.0° C./743 mmHg), 1,3-dimethoxy-2-propanol (169.0° C.), 1-methyl-1-cyclohexanol (168.0° C.), 7-menthanol (236.0° C.), isopropylbenzyl alcohol (246.0° C.), isobutylcarbinol (176-184° C.), benzyl alcohol (205.4° C.).

Polyhydric alcohols

propylene glycol (187° C.), ethylene glycol (197° C.), 1,3-butanediol (205-210° C.), 2,3-butanediol (182° C.), 1,4-butanediol (228° C.), 4-methyl-1,2-prpanediol (182° C.), 2-methyl-2,3-butanediol (177.5° C./750 mmHg), 1,5-pentanediol (242.5° C.), 1,6-hexanediol (134° C./10 mmHg), 2,5-hexanediol (218° C.), diethylene glycol (250° C.), 2-methyl-2,4-pentanediol (197.4° C.), 2-ethyl-1,3-hexanediol (240-250° C.), dipropylene glycol (215-245° C.), glycerol (290° C.).

Ethers

n-butyl ether (143° C.), isoamyl ether (173.2° C.).

Cyclic ethers

1,4-dioxane (101.4° C.), 1,3-dioxane (106° C.).

Esters

dimethyl succinate (195° C.), ethyl octanoate (208° C.), diethyl fumarate (214° C.), diethyl decanoate (242° C.), diethyl adipate (245° C.), methyl tartrate (280° C.), dietyl tartrate (288° C.).

Ketones

cyclopentanone (130.7° C.), 2-octanone (174° C.), 2-nonanone (195° C.), isophorone (215.2° C.), 2-undecanone (229° C.).

Ether alcohols

ethylene glycol monoethyl ether (134.8° C.), ethylene glycol monobutyl ether (167-173° C.), ethylene glycol dibutyl ether (203.6° C.), ethylene glycol monohexyl ether (208.1° C.), 1,3-dimethoxy-2-propanol (169° C.), diethylene glycol monomethyl ether (194.2° C.), diethylene glycol monoethyl ether (195° C.), diethylene glycol monobutyl ether (230° C.), tripropylene glycol monomethyl ether (242.5° C.), mono(polyoxyalkylene)ether of C₆-C₂₄ alkane- or alkene-diol such as an adduct of hexylene glycol and 1 mole of ethylene oxide or propylene oxide (Adduct 1 or 2), an adduct of hexylene glycol and 2 moles of ethylene oxide or propylene oxide (Adduct 3 or 4), an adduct of hexylene glycol and 4 mole of propylene oxide (Adduct 5) and an adduct of hexylene glycol and 2 moles of ethylene oxide which is further added with 1 mole of propylene oxide (Adduct 6) having properties as follows:

| | | Thermogravimetric analysis²⁾ | |
|---|---|---|---|
| | Water absorbance¹⁾ | Half value | Final temp. |
| | (%) | temp. (° C.) | (° C.) |
| Adduct 1 | 8 | 164 | 215 |
| Adduct 2 | 7.5 | 175 | 205 |
| Adduct 3 | 20 | 185 | 220 |
| Adduct 4 | 10 | 187 | 216 |
| Adduct 5 | 8 | 200 | 225 |
| Adduct 6 | 13 | 207 | 227 |

Note:
¹⁾Measured at 40° C. and 90% RH under 760 mmHg.
²⁾15-20 mg of the compound is analyzed at a temperature raising rate of 5° C./min. with an air flow rate of 50-60 ml/min.

These adducts may contain a small amount of diether used as a raw material or other unreacted compounds.

Ester alcohols

ethyl lactate (154° C.), ethyl glycolate (160° C.), 2-hydroxylethyl acetate (188° C.), diethyl L-maleate (253° C.).

Aminoalcohols

diethylethanolamine (163° C.), dibutylethanolamine (199° C.).

Carboxylic acids

pivalic acid (164° C.), isocrotonic acid (169° C.), isovaleric acid (177° C.), adipic acid (205.5° C.), hexanoic acid (205.8° C.), n-octanoic acid (239° C.), crotonic acid (189° C.).

Amides

n-ethylacetoamide (205° C.).

Primary, secondary and tertiary alcohols

2-octaneamine (163-164° C.), octylamine (188° C.), hexylamine (130° C./762 mmHg), 1,6-hexanediamine (81.5° C./10 mmHg), dibutylamine (160° C.), dicyclohexylammonium nitrite (255.8° C.), tripropylamine (157° C.), tributylamine (212° C.), 3-methyl-2-oxazolidinone (87-90° C./1 mmHg).

Imidazoles and Imidazolines

2-ethyl-4-methylimidazole (melting point, 44-55° C.), 2-ethyl-4-methylimidazoline (111° C./15 mmHg), 2-ethylimidazoline (110° C./15 mmHg), 2,4-dimethylimidazoline (108° C./15 mmHg), 1,2,3-benzotriazole (melting point, 93° C.).

Oxazolidinones

3-methyl-2-oxazolidinone (87-90° C./1 mmHg).

Monocyclic oxyterpenes

Υ-terpineol (114-115° C.), β-terpineol (209-210° C./752 mmHg), α-terpineol (219-221° C.), terpinen-4-ol (209-212° C.), maltol (sublimation at 93° C.), l-menthol (sublimation at 216.5° C.), d-camphor (sublimation at 209° C.).

Among these organic compounds, the poly- and mono-hydric alcohols and the ether alcohols are preferred.

The present invention will be hereinafter explained further in detail by following Examples.

### EXAMPLES 1-22

In Examples, used was a small-size DC motor of FIG. 5 having an outer diameter of 30 mm, a height of 25 mm and normal power of 0.1 W and comprising brushes made of sintered AgC and commutators made of phosphor bronze.

The motor contained a sheet of polyester felt 17 which had been washed and defatted with polyfluoroethylene and impregnated with each organic compound.

In each Example, following organic compound was used and the motor was operated on 4.2 V at 25 mA. The maximum period of time in which the motor was normally operated is shown in following Table 1. However, the operation was terminated at 1,500 hours.

TABLE 1

| Example No. | Organic compound | Operation time |
|---|---|---|
| 1 (comp.) | No organic compound | 300 hours |
| 2 (comp.) | Styrene | 100 hours |
| 3 (comp.) | Toluene | 300 hours |
| 4 | n-Dodecane | 1,500 hours |
| 5 | Benzyl alcohol | 1,500 hours |
| 6 | 2-Methyl-2,4-pentanediol | 1,500 hours |
| 7 | Isoamyl ether | 1,500 hours |
| 8 | 1,3-Dioxane | 1,500 hours |
| 9 | 2-Nonanone | 1,500 hours |
| 10 | 2-Methyl-2,4-pentanediol/ | 1,500 hours |
| | 1 mole of propylene oxide | |
| 11 | 2-Hydroxyethyl acetate | 1,500 hours |
| 12 | Diethyl fumarate | 1,500 hours |
| 13 | Dibutylethanolamine | 1,500 hours |
| 14 | Hexanoic acid | 1,500 hours |
| 15 | n-Ethylacetoamide | 1,500 hours |
| 16 | Octylamine | 1,500 hours |
| 17 | Dibutylamine | 1,500 hours |
| 18 | Tributylamine | 1,500 hours |
| 19 | 2-Ethyl-4-methylimidazole | 1,500 hours |
| 20 | α-Terpineol | 1,500 hours |
| 21 | 2-Methyl-2,4-pentanediol | 1,500 hours |
| | containing 50% of styrene | |
| 22 | 3-Methyl-2-oxazolidinone | 1,500 hours |

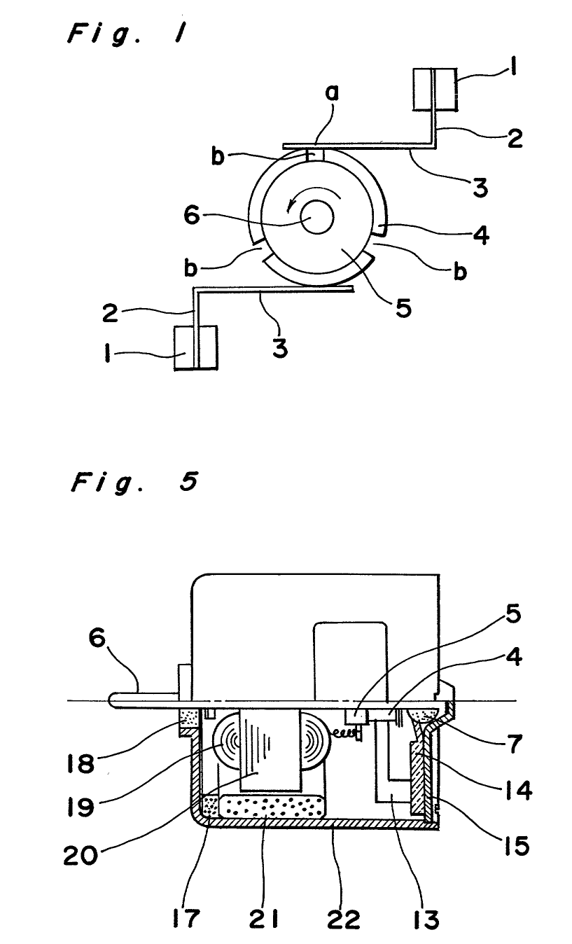

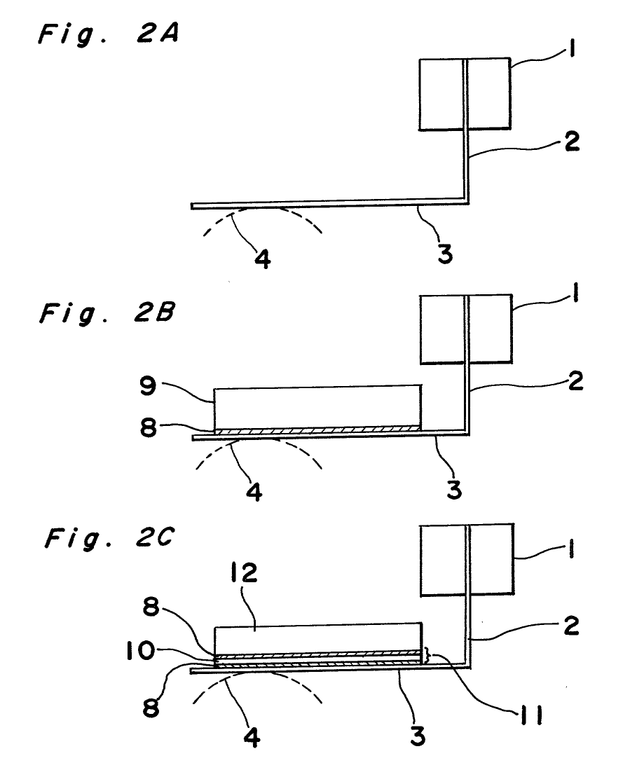

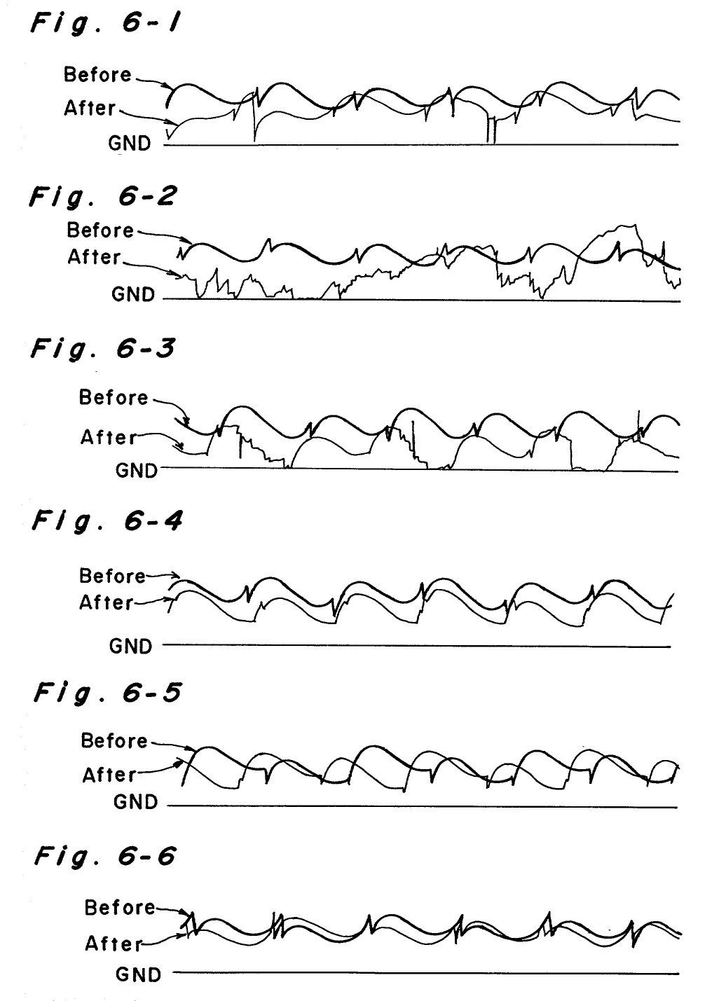

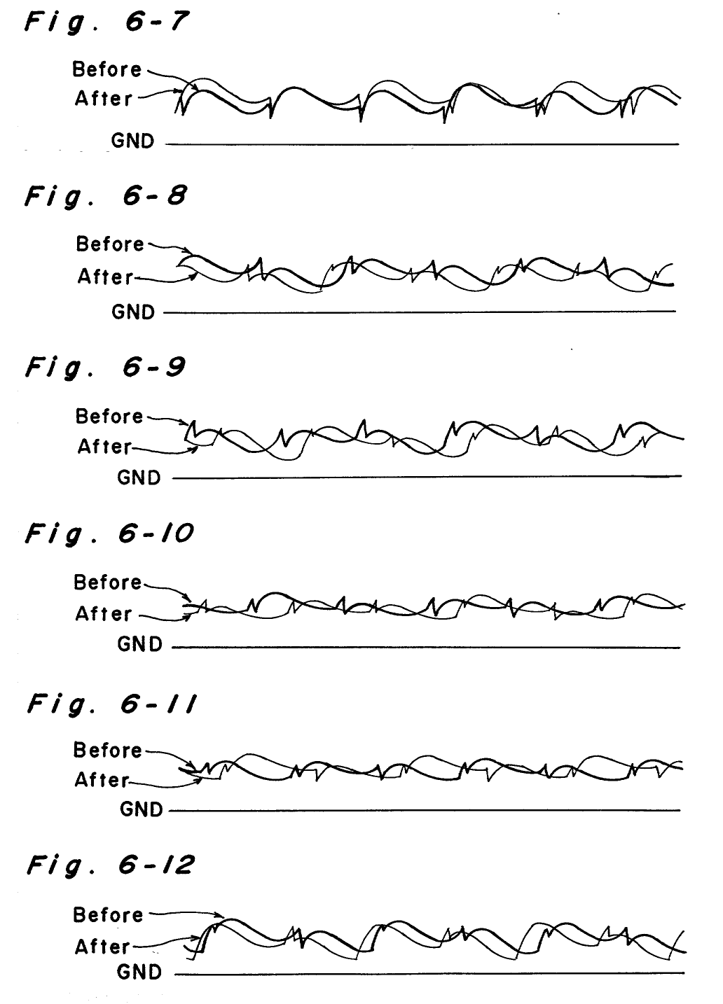

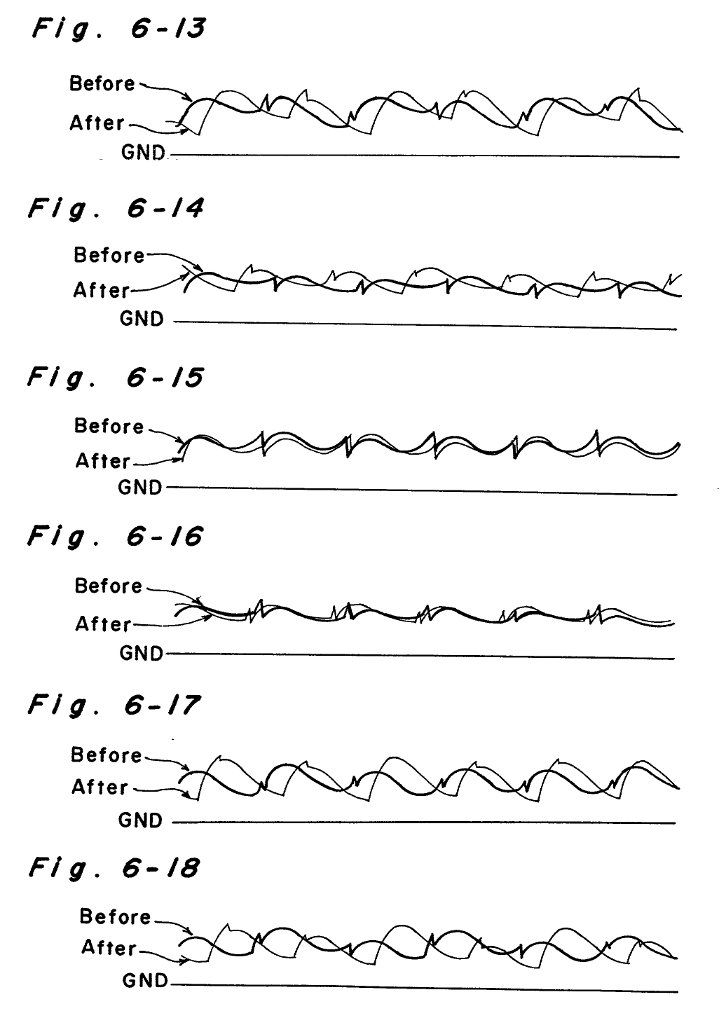

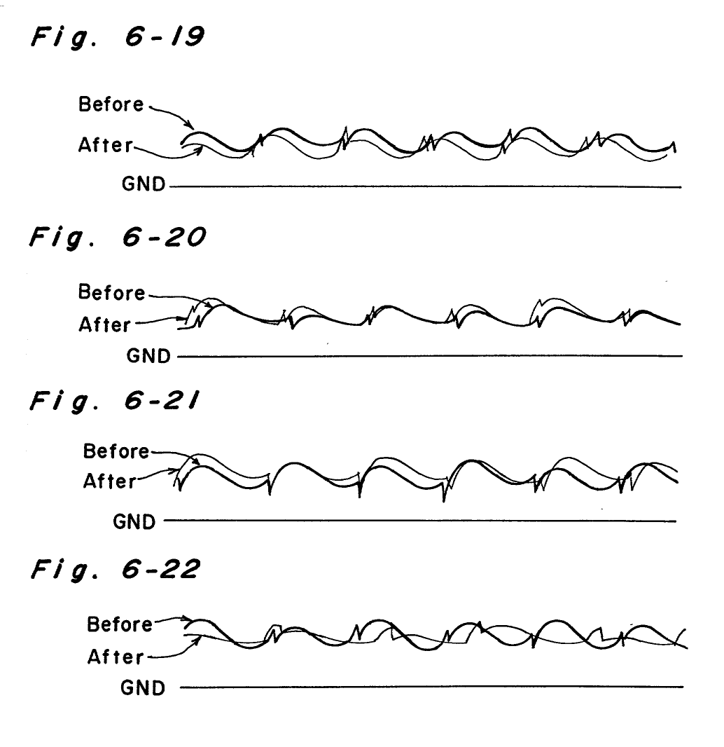

A commutating wave properly reflects the abnormality of the motor. An abnormal wave indicates the abnormal operation of the motor such as unstable revolution, increase of demand power, failure of starting and abnormal revolution. The abnormal wave means that the noise is added on the normal wave or the abnormal part of the wave falls to the ground (GND) level (current=0) as seen in FIGS. 6-1 to 6-3.

The commutating waves before and after operation are shown in FIGS. 6-1 to 6-22, in which bold and thin curves represent waves before and after operation, respectively.

As understood from these waves, the motors containing the organic compounds used according to the present invention are stably operated after 1,500 hours while the conventional motors containing no organic compound or the unsaturated cyclic compound cannot be stably operated only after 100 or 300 hours.

A motor having the same structure as that of FIG. 5, normal power of 0.04 W and comprising brushes cladded with AgPd and commutator made of a cladding material of AuAg and AdCd was operated on 12 V at 100 mA at a temperature of −10° C. and RH of 20-30%. The abrased amount of the brush, wow and flutter measured according to JIS C 5551, initial no-load current and initial no-load noise are shown in following Table 2.

TABLE 2

| | Abrased | Wow and | | |
|---|---|---|---|---|
| | amount | flutter | | |
| | of brush (μm) | (WTD) | Initial | Initial |
| Example | (after | (after | no-load | no-load |
| No. | 1,000 hrs) | 300 hrs) | current (mA) | noise (dB_{A}) |
| 1 | 25 | 0.1 | 30 | 28 |
| 2 | 2 | 0.33 | 28 | 27 |
| 3 | 3 | 0.25 | 28 | 27 |
| 4 | 10 | 0.088 | 27 | 26 |
| 5 | 15 | 0.075 | 28 | 27.5 |
| 6 | 5 | 0.07 | 27 | 26 |
| 7 | 8 | 0.09 | 28 | 26 |
| 8 | 10 | 0.1 | 27 | 28 |
| 9 | 7.5 | 0.08 | 27 | 26 |
| 10 | 8 | 0.07 | 28 | 27 |
| 11 | 7 | 0.08 | 28 | 27 |
| 12 | 7 | 0.07 | 29 | 28 |
| 13 | 5 | 0.095 | 29 | 27 |
| 14 | 6 | 0.08 | 28 | 26 |
| 15 | 6 | 0.08 | 27 | 27 |
| 16 | 7.5 | 0.085 | 28 | 27 |
| 17 | 10 | 0.07 | 28 | 27 |
| 18 | 9 | 0.075 | 28 | 28 |
| 19 | 8.5 | 0.08 | 29 | 27 |
| 20 | 10 | 0.07 | 28 | 27 |
| 21 | 10 | 0.088 | 27 | 26 |
| 22 | 8 | 0.09 | 27 | 26 |

According to the present invention, the organic compound is adsorbed on the surface of the brushes and the commutator segments and prevents the abrasion and welding of the sliding surfaces of them.

Even if the motor interior contains the vapor of the unsaturated cyclic compound such as styrene and toluene, the sliding surfaces of the brushes and the commutator segments are protected by the organic compound used according to the present invention so that the formation of the hard black material is prevented. Further, the imperfect contact between the brush and the commutator segment is prevented so that the electric noise is decreased and the motor is stably operated. This results in decrease of wow and flutter.

When the small-size motor with operating voltage of 1-30 V and operating current of 100 mA is operated in an atmosphere containing the vapor of the organic compound used according to the present invention, the current is decrease by 5-10% since the organic compound has a lubricating property.

In addition, the organic compound adsorbed on the surface of the brushes and the commutator segments have a damping effect to prevent vibration of the brushes caused by the sliding between the brushes and the commutator segments and thus decrease the mechanical noise by 1-10%.

What is claimed is:

1. A small-size motor of a type comprising an upper motor case and a lower motor case which closes an opening of the upper case, said upper motor case comprising a cylinder shaped case having a top covering at one end and an opening at the other end in which a bearing for supporting a shaft is provided at the center of the top covering in a thrust direction, said lower motor case being attached to the opening of the upper motor case to close said opening, said upper and lower motor cases housing brushes and a commutator slidably engaged with the brushes, characterized in that the motor case interior defined by the upper and lower motor case is filled with an atmosphere containing vapor of at least one organic compound selected from the group consisting of paraffins, mono- or poly-hydric alcohols, ethers, cyclic ethers, esters, ketones, ether alcohols, ester alcohols, aminoalcohols, carboxylic acids, amides, primary, secondary and tertiary amines, imidazoles, imidazolines and monocyclic oxyterpenes.

2. The small-size motor according to claim 1, wherein the organic compound is a polyhydric alcohol.

3. The small-size motor according to claim 1, wherein the organic compound is a monohydric alcohol.

4. The small-size motor according to claim 1, wherein the organic compound is an ether alcohol.

5. The small-size motor according to claim 1, wherein the organic compound is 2-methyl-2,4-pentanediol.

6. The small-size motor according to claim 1, wherein the organic compound is impregnated in a material selected from the group consisting of a sheet of felt and an open cell foam of a synthetic plastic, a synthetic rubber, a natural plastic and a natural rubber placed in the motor case interior defined by the upper and lower motor cases.

7. The small-size motor according to claim 1, wherein the organic compound is impregnated in magnet of the motor.

8. The small-size motor according to claim 1, wherein the organic compound is blended in a plastic bracket of the motor.

9. The small-size motor according to claim 1, wherein the organic compound is blended in a plastic commutator base of the motor.

10. The small-size motor according to claim 1, wherein the organic compound is impregnated in magnet wire of the motor.

11. The small-size motor according to claim 1, wherein the organic compound is blended in metal oil.

12. The small-size motor according to claim 1, wherein the organic compound is applied in a gap between the lower motor case and a magnet located on an inner surface of said lower motor case.

13. The small-size motor according to claim 1, wherein the organic compound is blended in a rubber vibration insulator which is adhered to said brush with an adhesive.

14. The small-size motor according to claim 1, wherein the organic compound is blended in an adhesive used to adhere a rubber vibration insulator to the brush.

15. The small-size motor according to claim 1, wherein the organic compound is contained in a gas permeable film and placed in the motor.

16. The small-size motor according to claim 15, wherein the gas permeable film is made of polyethylene.

17. The small-size motor according to claim 1, wherein the vapor of the organic compound is present in the motor case interior in amounts sufficient to form a mono- or poly-molecular layer on the surface of the brush and commutator so as to improve the lubricity of said surfaces when in contact with each other, thereby avoiding abrasion of said surfaces.

18. The small-size motor according to claim 1, wherein the organic compound has a boiling point or sublimation point of 40° C. to 350° C.
